(19) United States
(12) Patent Application Publication
(10) Pub. No.: US 2009/0288614 A1
(43) Pub. Date: Nov. 26, 2009

(54) COVER FOR CALF HUT

(76) Inventor: Kevin Connot, Allen, NE (US)

Correspondence Address: ZARLEY LAW FIRM P.L.C., CAPITAL SQUARE, 400 LOCUST, SUITE 200, DES MOINES, IA, 50309-2350, US

(21) Appl. No.: 12/467,345

(22) Filed: May 18, 2009

Related U.S. Application Data
(60) Provisional application No. 61/055,624, filed on May 23, 2008.

(51) Int. Cl. A01K 1/00

(52) U.S. Cl. 119/501; 119/482

(57) ABSTRACT

A calf hut assembly for shielding and protecting a calf. The calf hut assembly comprising a calf hut having a top, end walls and sidewalls. The calf hut assembly has an opening in an end wall and a support member connected to the calf hut. The calf hut assembly has a cover with a support member wherein the cover has a clear material. This allows a calf o see outside the calf hut. Additionally, this allows sunlight to pass into the interior of the calf hut thereby warming the calf hut.

### CROSS REFERENCE TO A RELATED APPLICATION

This application is a continuation of U.S. Provisional Patent Application Ser. No. 61/055,624 filed May 23, 2008.

### BACKGROUND OF THE INVENTION

This invention is directed to a calf hut and more specifically to a cover for a calf hut.

Calf huts are well known in the art and are used during adverse weather situations to protect calves from moisture and cold. While these devices assist in protecting calves, wind and rain can still enter the interior of the hut through a main opening. Further, when enclosed, sunlight is prevented from entering the interior to provide heat. Thus, a need exists in the art for a device that addresses these deficiencies.

The objective of this invention is to provide a cover for a calf hut that allows sunlight into the interior to provide heat while keeping out other elements.

### BRIEF SUMMARY OF THE INVENTION

A calf hut assembly for housing and protecting a calf from the adverse weather conditions. The calf hut assembly comprising a calf hut having a top, end wall and sidewalls. The calf hut assembly having an opening in an end wall, a support member connected to the calf hut, and a cover connected to the support member wherein the cover is made of clear material. This provides the advantages of shielding the calf from adverse weather conditions while allowing sunlight to enter into the hollow interior and warm the calf hut.

### BRIEF DESCRIPTION OF THE DRAWINGS

FIG. 1 is a perspective view of a calf hut with a cover having an attached support member with the cover being disengaged from the calf hut;

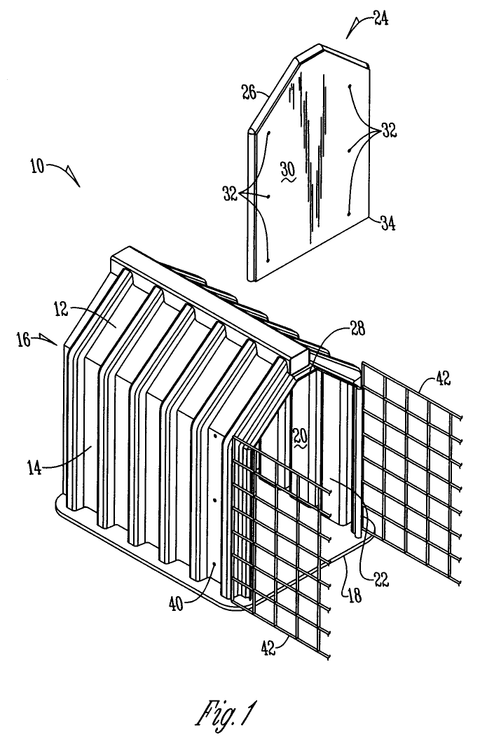

FIG. 2 is a perspective view of a calf hut with the cover in place over the opening;

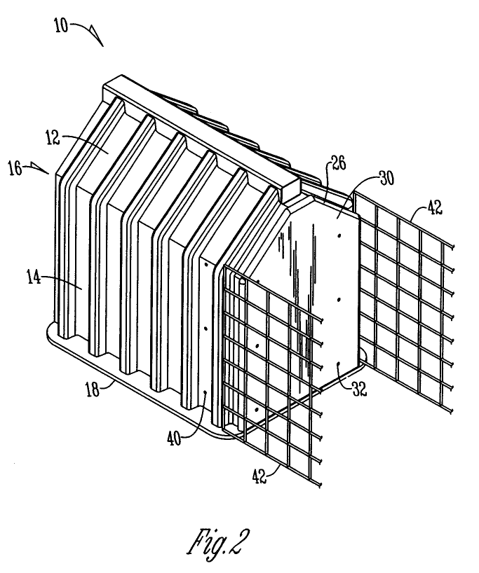

FIG. 3 is a perspective view of a calf hut having a support member connected to a molded projection surrounding the opening and a cover which is disengaged from the calf hut; and

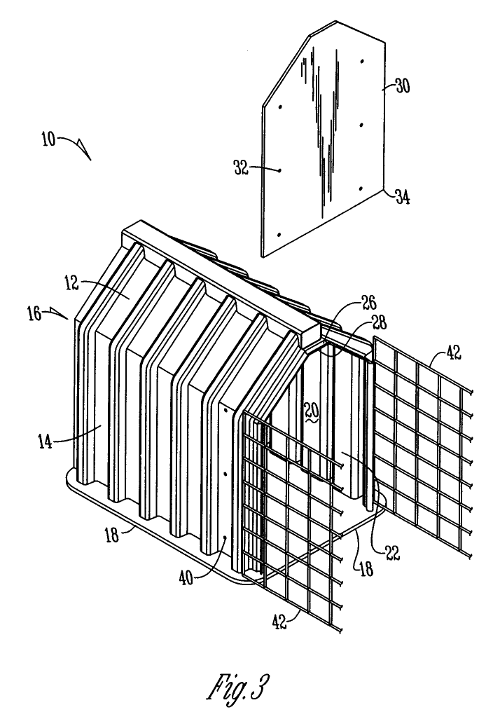

FIG. 4 is a perspective view of a calf hut having a cover held in place by straps.

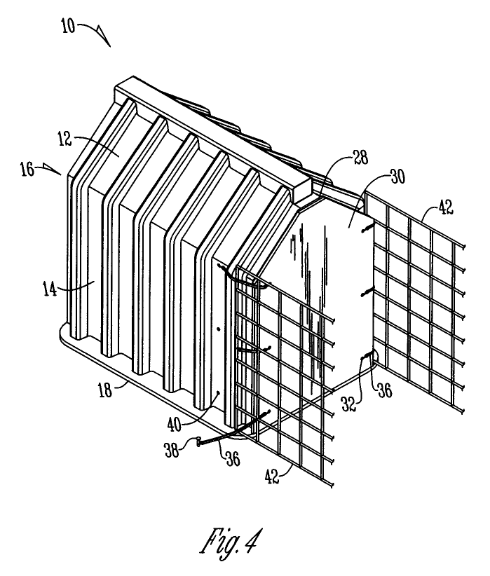

### DETAILED DESCRIPTION OF THE PREFERRED EMBODIMENT

A calf hut 10 has a top 12, sidewalls 14, end walls 16, and a bottom 18 that form a hollow interior 20. One of the end walls 16 has an opening 22 through which a calf enters and exits the hut.

A cover 24 has a support member 26 preferably made of galvanized 1⅜″ tubing that is formed to engage a molded projection 28 surrounding the opening 22 in the end wall. A piece of clear material 30 is attached to the support member 26 and extends across and fully encompasses the opening 22 when the support member 26 is positioned around the molded projection 28. In a preferred embodiment the clear material is clear vinyl. In another embodiment the clear vinyl is a clear reinforced vinyl that is sewn into the support member 26 to provide a solid cover. The clear material 30 has four grommets 32 attached to the corners 34 of the vinyl. Extending from the grommets 32 are straps 36. The straps 36 are of any type such as a ball bungee with a J-hook of approximately 7 to 9 inches. Alternatively a tarp strap is used. The strap 36 extends from the grommet 32 to a stake 38 that is inserted in the ground near the calf hut 10. Alternatively, the straps 36 extend to and are connected to eyelets 40 that are attached to the sidewalls 14 of the calf hut 10, or to a surrounding containment fence 42.

In operation the clear material 30 is attached to the support member 26. Once attached the support member 26 is placed over the opening 22. Stakes 38 are inserted in the ground near the opening 22 and the straps 36 are attached to the stakes 38 or eyelets 40 to hold the cover 24 firmly against the calf hut to enclose the opening 22. In this manner the cover 24 allows sunlight into the hollow interior 20 through the clear material 30 while keeping the elements out of the hollow interior. Thus, at the very least all of the objectives have been met.

It will be appreciated by those skilled in the art that other various modifications could be made to the device without departing from the spirit and scope of this invention. All such modifications and changes fall within the scope of the claims and are intended to be covered thereby.

What is claimed is:

1. A calf hut assembly, comprising:
a calf hut having a top, end walls, and side walls;
an opening in an end wall; and
a cover having a support member attached to a clear material.

2. The calf hut assembly of claim 1 further comprising the support member made of galvanized tubing.

3. The calf hut assembly of claim 1 wherein the support member is connected to a molded projection surrounding the opening.

4. The calf hut assembly of claim 1 wherein the clear material is clear vinyl.

5. The calf hut assembly of claim 1 wherein the cover extends across the opening.

6. The calf hut assembly of claim 1 wherein the cover has a grommet attached to a corner.

7. The calf hut assembly of claim 1 wherein at least one strap is connected to the cover.

8. The calf hut assembly of claim 1 wherein a side wall has an eyelet.

9. The calf hut assembly of claim 1 wherein a containment fence is connected to the calf hut.

10. The calf hut assembly of claim 1 wherein the cover is held in place by a bungee.

11. A calf hut assembly comprising:
a calf hut having a hollow interior and an opening of size and shape to permit a calf to enter the calf hut;
a cover having a support member attached to a clear material that is held against the calf hut to enclose the opening; and
wherein the cover allows sunlight into the hollow interior through the clear material.

12. The assembly of claim 11 wherein the clear material is clear vinyl.

13. The assembly of claim 11 wherein the clear material fully encompasses the opening of the calf hut.
